(19) United States
(12) Patent Application Publication
(10) Pub. No.: US 2008/0281518 A1
(43) Pub. Date: Nov. 13, 2008

(54) Vehicular communication and information system and method of using the same

(76) Inventors: Chad A. Dozier, Laurel, MS (US); Marion Wesley Simpson, Laurel, MS (US); Wolf Scott, Brandon, MS (US); Jason Gaon, Las Vegas, NV (US)

Correspondence Address: LITMAN LAW OFFICES, LTD., P.O. BOX 15035, CRYSTAL CITY STATION, ARLINGTON, VA, 22215-0035, US

(21) Appl. No.: 11/798,173

(22) Filed: May 10, 2007

(51) Int. Cl. G01C 21/00; G06F 19/00

(52) U.S. Cl. 701/213; 701/207; 701/35

(57) ABSTRACT

The vehicular communication and information system provides a computer system mounted within a vehicle, with a global positioning system receiver being in communication with the computer system. Location and motion data related to the vehicle are recorded within a first data storage medium associated with the vehicle-based computer system, and the data are further transmitted to a base station, to be stored in a second data storage medium. The location and motion data, which may include the vehicle's position, speed and direction, are selectively displayed on a display located within the vehicle, and also displayed at the base station. A user within the vehicle or personnel at the base station may produce reports containing the vehicle-specific data, and may further define geographic boundaries within which the vehicle is authorized to move. Alarm signals may be generated within the vehicle or at the base station if the vehicle moves beyond the boundary.

### BACKGROUND OF THE INVENTION

1. Field of the Invention

The present invention relates to a vehicular communication and information system, and a method of using the same. Particularly, the system includes a computer system mounted within a vehicle, with a global positioning system receiver being in communication with the computer system. Location and motion data related to the vehicle are recorded within a first data storage medium associated with the vehicle-based computer system, and the data are further transmitted to a base station, to be stored in a second data storage medium.

2. Description of the Related Art

Global positioning system (GPS) receivers for automobiles, trucks and the like are well known in the art. Such systems typically receive locating signals from one or more GPS satellites and display location coordinates to the driver of the vehicle. Similarly, navigational systems for vehicles are well known, with such systems typically determining the present location of the vehicle and superimposing the vehicle's location on a virtual map, providing driving directions to the user.

Such systems, however, only provide current location and navigational data, and do not incorporate storage media for recording the path or route followed by the vehicle. Further, such systems are typically “stand-alone” systems; i.e., they perform the singular function of providing navigation or location information, and do not incorporate separate features which the user may wish to employ, such as, for example, voice communication.

If the user wishes to link a GPS navigation system with, for example, access to the Internet within his or her vehicle, separate systems must be employed and manually linked together. In addition to the size and dimensional limitations within a vehicle, it is often difficult to interface separate electronic or computerized devices with one another.

Thus, it would be desirable to provide an integrated communication and information system, combining navigational and location-based features with a variety of computerized services. None of the above inventions, taken either singly or in combination, is seen to describe the instant invention as claimed. Thus, a vehicular communication and information system solving the aforementioned problems is desired.

### SUMMARY OF THE INVENTION

The vehicular communication and information system is directed towards a mobile computer system for use in a vehicle. The system includes a central computer equipped with interface peripherals, such as a monitor, keyboard, auxiliary controls (if desired), a printer and removable storage media. The computer, monitor, keyboard, printer and other related computer system elements are provided with respective mounting brackets for securely and stably mounting the computer system within the vehicle for use by the driver and/or passengers.

A power supply is provided, allowing the system to either draw power from the vehicle battery, or from a separate power source (such as an auxiliary battery, stored in the vehicle). The power supply preferably further includes a shut-down controller for properly shutting down power to the computer responsive to the on-off condition of the ignition. The system further includes a global positioning satellite (GPS) receiver, allowing for the computer to receive and calculate positional data with respect to the vehicle's location. Preferably, the on-board computer system, to be described in greater below, is powered responsive to the power supplied to the vehicle ignition, allowing for shut-down and start-up of the computer simultaneously with the vehicle, with the original settings and data being saved on shut-down. The settings saved on shut-down are then loaded upon the next start-up to be presented to the user. Each such shut-down and start-up is referred to as an “event” in conjunction with the software running on the computer system.

The system further includes a wireless transceiver, allowing for conventional communication with a base station, which may include voice or data transmission, for example. The GPS sub-system not only allows for conventional positioning of the vehicle's location (and subsequent display on a virtual map, displayed on the computer monitor), but may also track the vehicle's path, which may be recorded either on the vehicular computer system (and saved on the removable storage media) and/or recorded at the stationary base station. Such tracking may be useful for both providing directional information, and further for recording events, such as vehicle accident data and the like.

The wireless interface between the on-board vehicular computer system and the stationary base station allows for control signals to be transmitted to the vehicular computer. The vehicular computer is preferably interfaced with the vehicle's electrical system such that the control signals may, for example, remotely unlock the vehicle doors, disable the vehicle (in case of theft or emergency), or monitor the vehicle's condition. Further, vehicle maintenance information may be displayed to the user. For example, when the user's “check engine” light is actuated, the vehicular computer system may interface with the vehicle's pre-installed computer to determine the exact nature of the problem. Vehicle maintenance computers for analyzing vehicle problems through interface with pre-installed computers are well known. However, such system are typically large and only available in vehicle repair shops and the like. The present system is provided to the user within the vehicle, integrated into the on-board computer system.

The GPS interface may be used to provide the user with relevant maps, directional information, and to provide route-based information, such as arrival and departure notifications. Further, the user may program a virtual boundary or “virtual fence”, thus generating an alert signal if the vehicle passes beyond the defined perimeter of the virtual fence. Virtual fences may be alternatively referred to as “Geofences” and/or telemetry. Conditional information, such as whether the vehicle is stopped, moving, etc., may further be recorded and/or generate condition-specific signals, either to the vehicular users or to the base station.

The computer and wireless interface further allow the user to access a large scale computer network, such as the Internet, allowing either the driver or passengers to explore the World Wide Web, send e-mail, transmit instant messages, and the like. Passengers may access the computer system (which is preferably positioned adjacent the driver) via a remote control or wireless interface. The network information may be coupled with the GPS interface, allowing for access and display of position-based information. For example, information about local landmarks, shops or geological features may be displayed on or adjacent a map, based upon the vehicle's location.

These and other features of the present invention will become readily apparent upon further review of the following specification and drawings.

### BRIEF DESCRIPTION OF THE DRAWINGS

FIG. 1 is an environmental, perspective view of a vehicular communication and information system according to the present invention.

FIG. 2 is a schematic, block diagram illustrating the components of the vehicular communication and information system according to the present invention.

FIG. 3 is a diagrammatic view of the subject vehicular communication and information system in use during transit.

FIG. 4 is a first screen shot illustrating a first set of informational and communication functions performed by the vehicular communication and information system according to the present invention.

FIG. 5 is a second screen shot illustrating a second set of informational and communication functions performed by the vehicular communication and information system according to the present invention.

FIG. 6 is a third screen shot illustrating a third set of informational and communication functions performed by the vehicular communication and information system according to the present invention.

FIG. 7 is a fourth screen shot illustrating a fourth set of informational and communication functions performed by the vehicular communication and information system according to the present invention.

Similar reference characters denote corresponding features consistently throughout the attached drawings.

### DETAILED DESCRIPTION OF THE PREFERRED EMBODIMENTS

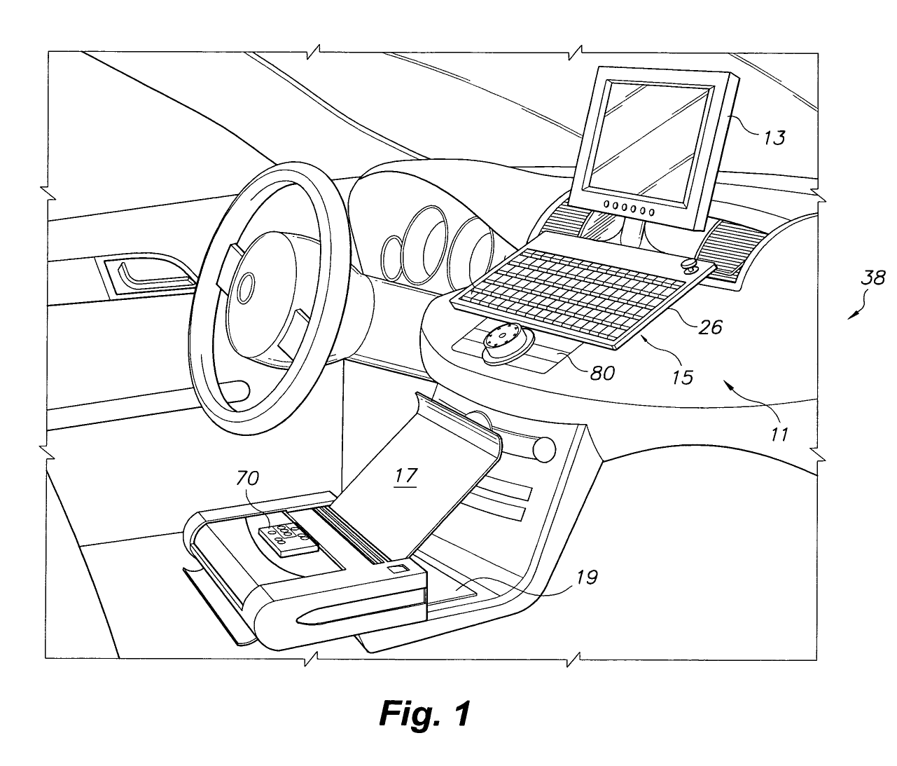

As best shown in FIGS. 1-3 of the Drawings, the vehicular communication and information system 11 is a mobile computer system for use in a vehicle. The system includes a central computer 28 equipped with interface peripherals, such as a monitor 13, keyboard 15, auxiliary controls 80 (if desired), a printer 17 and removable storage media 32. The computer 28, monitor 13, keyboard 15, printer 17 and other related computer system elements are provided with respective mounting brackets 19, 26 for securely and stably mounting the computer system within the vehicle for use by the driver and/or passengers. It should be understood that the computer 28 and associated peripheral elements may be mounted within the interior of the vehicle through the usage of any suitable releasable or permanent mounting devices, dependent upon the particular needs and desires of the user.

It should be understood that any suitable computer or programmable processor system may be utilized, dependent upon the particular needs and desires of the user. In the preferred embodiment, computer 28 is preferably a model MP-SC3-CS2 Mini P4 Aluminum Car PC, manufactured by Xenarc® Technologies of Fountain Valley, Calif. This preferred system is a multimedia personal computer adapted for GPS navigation (as will be described in further detail below), MP3 format audio playback, in-vehicle theater multimedia entertainment, in-vehicle computer gaming, and in-vehicle office functions.

The preferred computer 28 has a substantially parallelepiped-type contour, having a width of approximately 5.75 inches, a length of approximately 9.84 inches, and a height of approximately 1.65 inches. Computer 28 is preferably dimensioned and contoured to be mounted either within the interior of the vehicle, or mounted within a storage space, such as the vehicle's trunk. The preferred computer 28 weighs approximately 2 lbs., and the MP-SC3-CS2 Mini P4 Aluminum Car PC includes an Intel® Pentium® 4 processor housed within an aluminum casing (for thermal conduction and cooling of the processor and processing components).

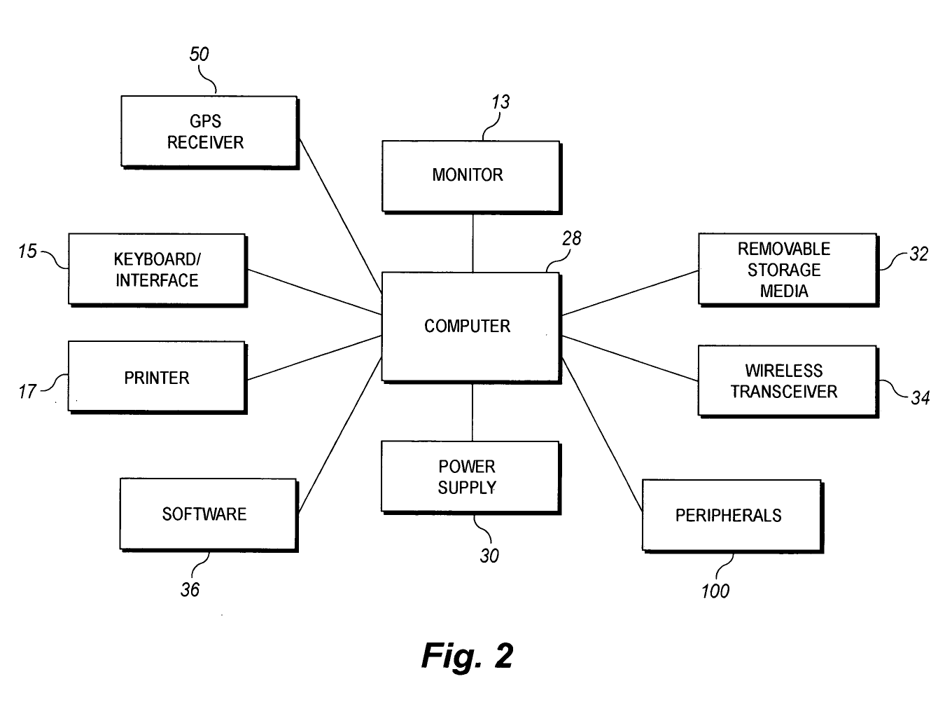

Computer 28 includes a power supply 30, which is preferably a 12V DC interface and transformer, allowing the computer 28 to be powered by the vehicle's battery. Computer 28 includes removable storage media, which may be in the form of a CD-ROM, DVD-ROM, CD-RW, or DVD-ROM/CD-RW combo drive, or any other suitable removable storage media, dependent upon the particular needs and desires of the user. It should be understood that power supply 30 may either draw power from the vehicle battery, or from a separate power source (such as an auxiliary battery, stored in the vehicle). Any suitable peripherals, dependent upon the needs of the user, may be added to the system (shown generally as 100 in FIG. 2).

The system further includes a global positioning system (GPS) receiver 50, allowing for the computer 28 to receive and calculate positional data with respect to the location of vehicle 38. Any suitable GPS receiver may be utilized, however, in the preferred embodiment, system 11 utilizes a “Locator 6000”, manufactured by Webtech Wireless. GPS receiver 50 and computer 28 are equipped with navigational software, such as Microsoft® MapPoint®2006, for example, allowing the user's location and additional navigational information (to be described in detail below), to be displayed on monitor 13. It should be understood that the above navigational software is listed for exemplary purposes only. Preferably, GeoNav 1.0 software is utilized, which utilizes the internal engine of Microsoft® MapPoint®, but is then customized and reconfigured for specific, user-selective integration into the on-board computer system. Any suitable software may be utilized.

It should be understood that any suitable GPS receiver system may be utilized, dependent upon the particular needs and desires of the user. Similarly, it should be understood that any suitable display monitor 13 may be used, dependent upon the particular needs and desires of the user. In the preferred embodiment, monitor 13 is a touch-screen, liquid crystal display monitor, having a diagonal screen length of approximately 7 inches, for example, and being in communication with computer 28 through, preferably, a universal serial bus interface. Monitor 13 is preferably powered by the vehicle's battery and may include a power interface adapted for reception within the vehicle's cigarette lighter.

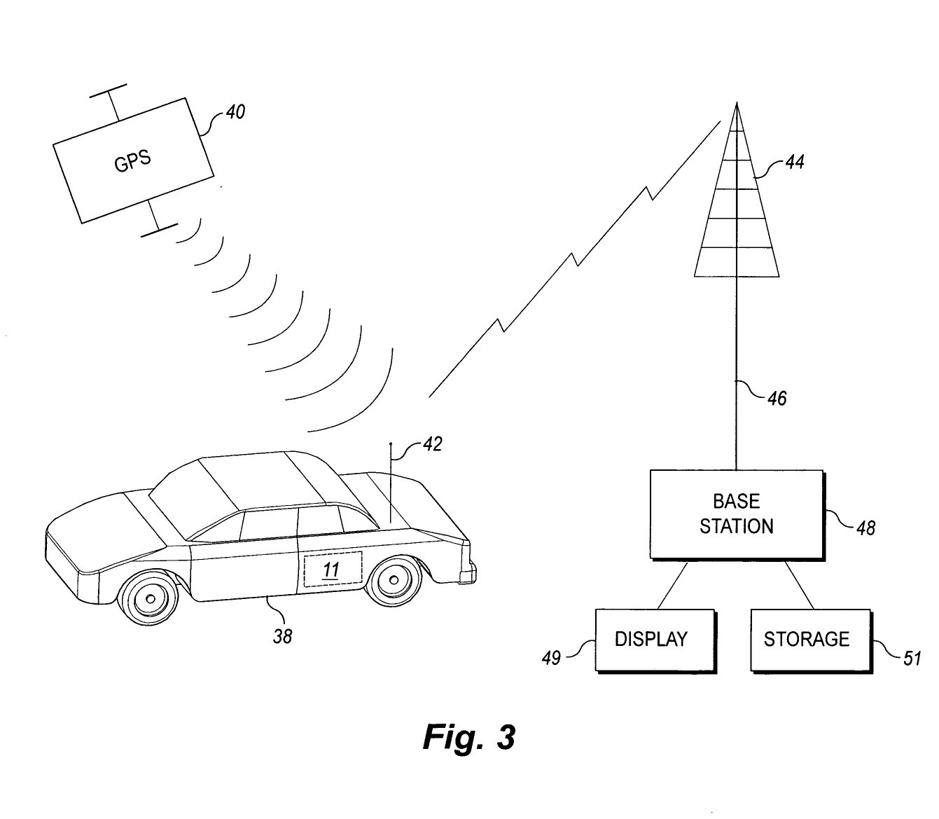

The system further includes a wireless transceiver 34, allowing for conventional communication with a base station 48, which may include voice or data transmission, for example. As best shown in FIG. 3, vehicle 38 is equipped with one or more antennae 42. Antenna 42 receives signals from the GPS satellite network 40, and is in communication with GPS receiver 50 for providing positional information to computer 28. Antenna system 42 further acts as a transmitter and receiver for communication with base station 48.

In FIG. 3, antenna system 42 sends and receives wireless signals to cellular tower 44. Preferably, system 11 is capable of voice and data transmission over a conventional cellular system. However, it should be understood that any suitable wireless transmissions may be utilized for communication. Cellular tower 44 is in communication, via line 46 (which may be a standard telephone exchange, for example), with base station 48. Preferably, the on-board computer system includes a “listener” sub-system, which reads and interprets the particular IP address associated with the cellular tower 44 and the tower's cellular network provider, for example, the provider may be Cingular Wireless® or equivalent companies. This IP address is then delivered to the server at the base station for conversion and transmission back to the vehicle system in order to update and change the mobile IP address. The vehicle computer system, thus, does not “roam” on any particular cellular network.

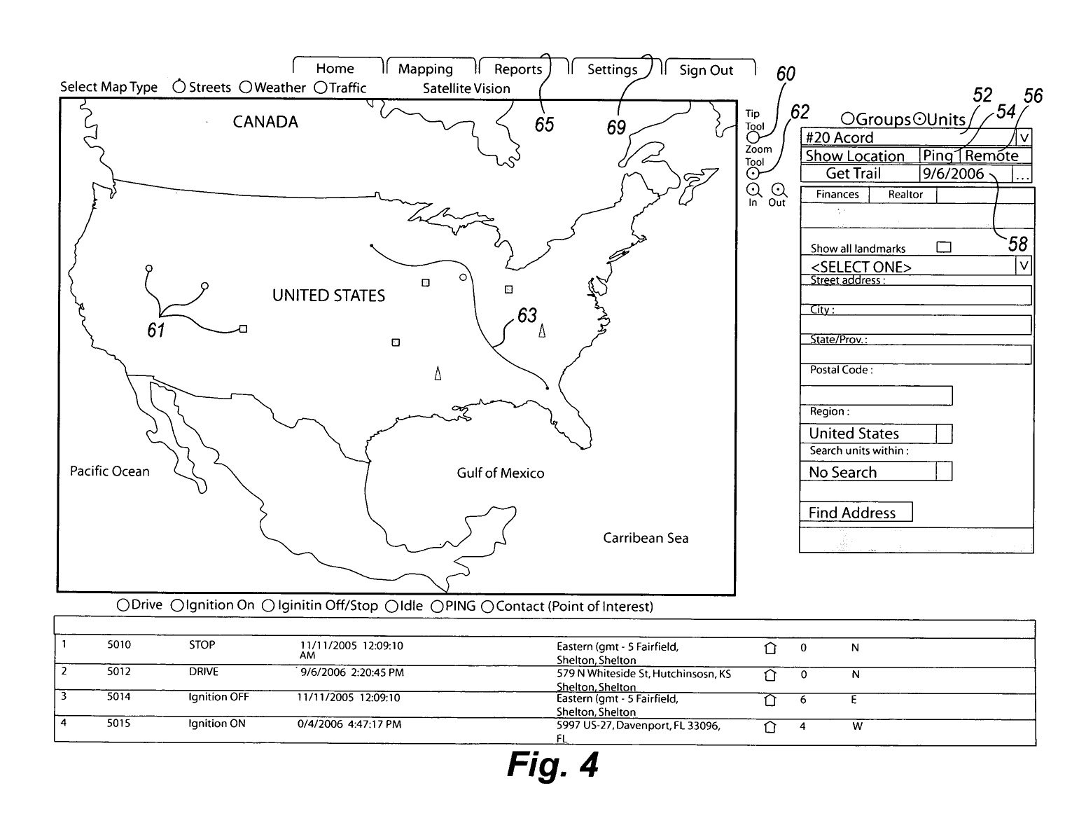

The GPS receiver 50 not only allows for conventional positioning of the vehicle's location (and subsequent display on a virtual map, such as that illustrated in FIG. 4, displayed on the computer monitor 13), but may also track the vehicle's path, which may be recorded either on the vehicular computer system 11 (and saved on the removable storage media 32) and/or recorded at the stationary base station 48. Such tracking may be useful for both providing directional information, and further for recording events, such as vehicle accident data and the like. In one specific example, officers of state departments of transportation, who may pull over trucks and the like, may produce printed reports for hours driven for each particular driver. Stationary base station 48 may include one or more displays 49 (such as computer monitors or the like) and one or more storage media 51 for, respectively, displaying and storing the vehicle location and motion-based data transmitted via transceiver 34 through antenna 42.

Printer 17 may be any suitable printer system, adapted for usage within the interior of vehicle 38. System 11 may further include auxiliary controls 80, allowing the user to integrate standard vehicle functions (such as control over the radio or environmental systems, for example) into system 11. System 11 may be utilized by either the driver when the vehicle is not in motion, or may be used by a passenger within vehicle 38. A remote control or wireless interface device 70 may be provided, allowing passengers in the back seat of vehicle 38 to easily access computer 28.

The wireless interface between the on-board vehicular computer system 11 and the stationary base station 48 further allows for control signals to be transmitted to the vehicular computer 28. The vehicular computer 28 is preferably interfaced with the vehicle's electrical system such that the control signals may, for example, remotely unlock the vehicle doors, disable the vehicle (in case of theft or emergency), or monitor the vehicle's condition. Further, vehicle maintenance information may be displayed to the user. For example, when the user's “check engine” light is actuated, the vehicular computer system 28 may interface with the vehicle's pre-installed computer to determine the exact nature of the problem.

The GPS interface 50 may further be used to provide the user with relevant maps, directional information, and to provide route-based information, such as arrival and departure notifications. Further, the user may program a virtual boundary or “virtual fence”, thus generating an alert signal if the vehicle passes beyond the defined perimeter of the virtual fence. Conditional information, such as whether the vehicle is stopped, moving, etc., may further be recorded and/or generate condition-specific signals, either to the vehicular users or to the base station 48.

Software 36 associated with computer 28 provides for both voice and data communication between the vehicular users and personnel within base station 48 (or users connected external to base station 48 through the Internet or the like), and further allows personnel within base station 48 to locate the nearest vehicle equipped with system 11 (either nearest to base station 48, or to a set landmark, via a network of cellular receiver towers 44).

As noted above, computer system 11 is preferably integrated into the pre-installed computer system of vehicle 38. Thus, personnel within base station 48 may monitor the conditions of vehicle 38, such as whether the driver is speeding, making unauthorized stops, or traveling within unauthorized geographic zones. When computer 28 determines that one of these conditions (or any conditions pre-set and programmed by the users) has been met, an alert signal is generated, either to be delivered to the vehicular users, and/or transmitted to base station 48 via antenna 42. Further, system 11 allows for the generation of reports on various vehicular conditions, either to be provided to the driver and passengers, or to personnel within base station 48.

The computer 28 and wireless interface 42 further allow the user to access a large scale computer network, such as the Internet, allowing either the driver or passengers to explore the World Wide Web, send e-mail, transmit instant messages, and the like. Passengers may access the computer system 28 (which is preferably positioned adjacent the driver, as shown in FIG. 1) via a remote control or wireless interface 70. The network information may be coupled with the GPS interface 50, allowing for access and display of position-based information. For example, information about local landmarks, shops or geological features may be displayed on or adjacent a map, based upon the vehicle's location.

FIG. 4 shows an exemplary screen display (displayed on monitor 13), illustrating a mapping application. In addition to displaying a route map based upon either the user's present location (located via the GPS interface) or the user's intended destination or route, the system, in conjunction with software 36, allows the user to enter a geographic grouping of locations or features. These are entered in the input box designated 52. The user may further send a communication “ping” in a conventional manner via virtual button 54, actuate a remote interface (for access by the base station personnel or other remote users) at 56, enter time and date data at 58, receive informational “tips” or information regarding either the route or specific features on the map at 60, or zoom in or out on the map at 62.

As shown in the lower portion of the screen, typewritten navigational directions are also provided. The screen shown in FIG. 4 is the main or mapping screen of the navigational program, accessed by the “mapping” tab, located on the upper portion of the screen. As further shown, the user may set the map to include standard geographical or navigational features, such as roads, or may view traffic or weather-related maps, accessed through the wireless connection to the Internet or other network.

If the map is accessed by the base station, the base station personnel may inquire as to locations of particular “units”; i.e., vehicles equipped with system 11. One or more selected units may be displayed on the map. A description of the date, address, speed, heading and unit ID is viewable at the bottom of the map page. It should be understood that this display may either present real-time data, or may display stored data, showing a tracking route of events happening at a specific date and time in the past. Accessing the ping function displays the present geographic location, on the map, of the unit or units of interest.

As described above, the user may utilize the remote feature (button 56) to either generate remote control signals (such as unlocking the vehicle door remotely, for example), or to access information on computer 28 remotely. In FIG. 4, the user's route or intended route is labeled as 63 and the various markers 61 indicate user-defined features or locations of interest. It should be understood that the screen displays in FIGS. 4-7 may be displayed to the user in the vehicle (via monitor 13) or may be displayed to personnel located at base station 48 via display 49.

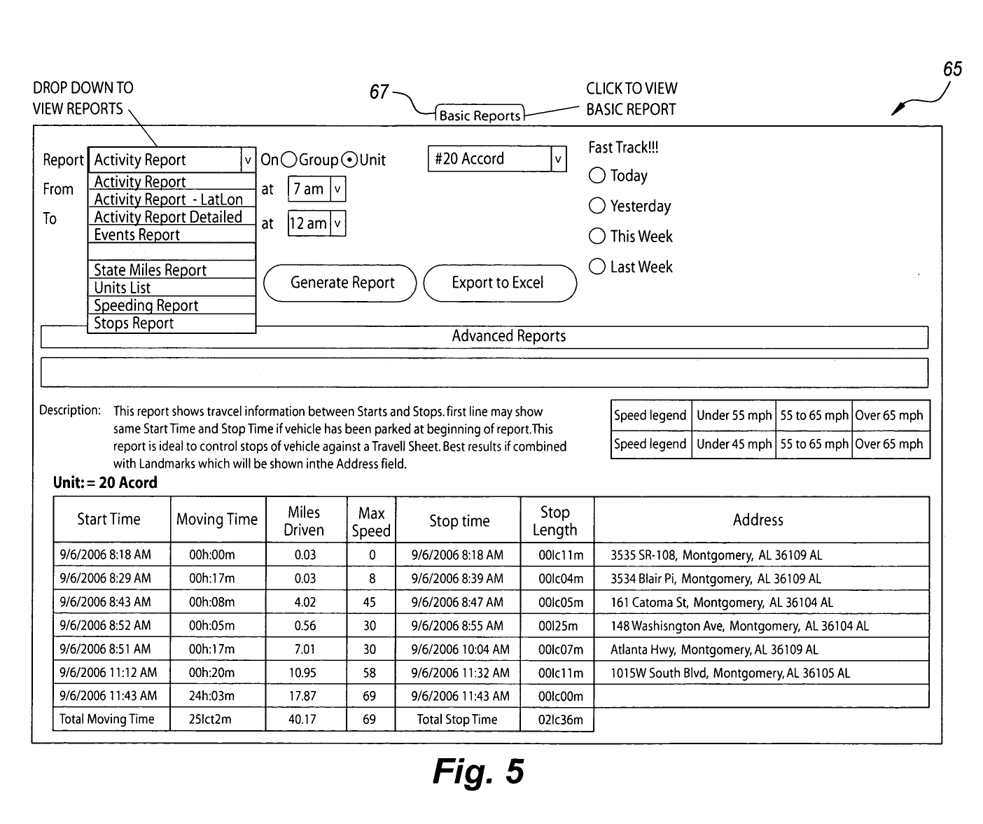

If the user selects the “reports” tab 65, the user accesses a route information display, illustrated in FIG. 5. It should be understood that the features illustrated in FIGS. 4-7 are shown for exemplary purposes only, and may have any desired visual appearance or configuration. In FIG. 5, stored reports of the vehicle's movements are accessed and displayed. The user may select a particular type of report, or reports, from a set day. The report, as shown, gives time, distance and destination information, along with average speed of travel. These reports may be displayed on monitor 13 or saved, either on the storage media 32 or on a system remotely located at base station 48. The information may be saved in any desired format.

An “activity report”, if selected, shows a description of travel information between starts and stops of the vehicle of interest. The report further includes a listing of total moving time, distance driven, and maximum speed recorded for the generated activity report. The user may selectively control how much information is displayed. For example, the user may select to view an “events report”, which provides a detailed summary of the above information for a specific time period; an “events summary report”, which shows the time and percentage of stops, idle and driving time; a “state mileage report”, which shows the distance traveled within each state of travel; a “speeding report”, which shows the speeds of the vehicle in a specific period of time; and a “stops report”, which shows the stops of the vehicle in a selected period of time. The user may filter the “stops report” to display stops only above a certain time threshold. It should be understood that any desired information may be extracted from system 11 and stored in (and displayed on) a report, with the type of data being user-selectable.

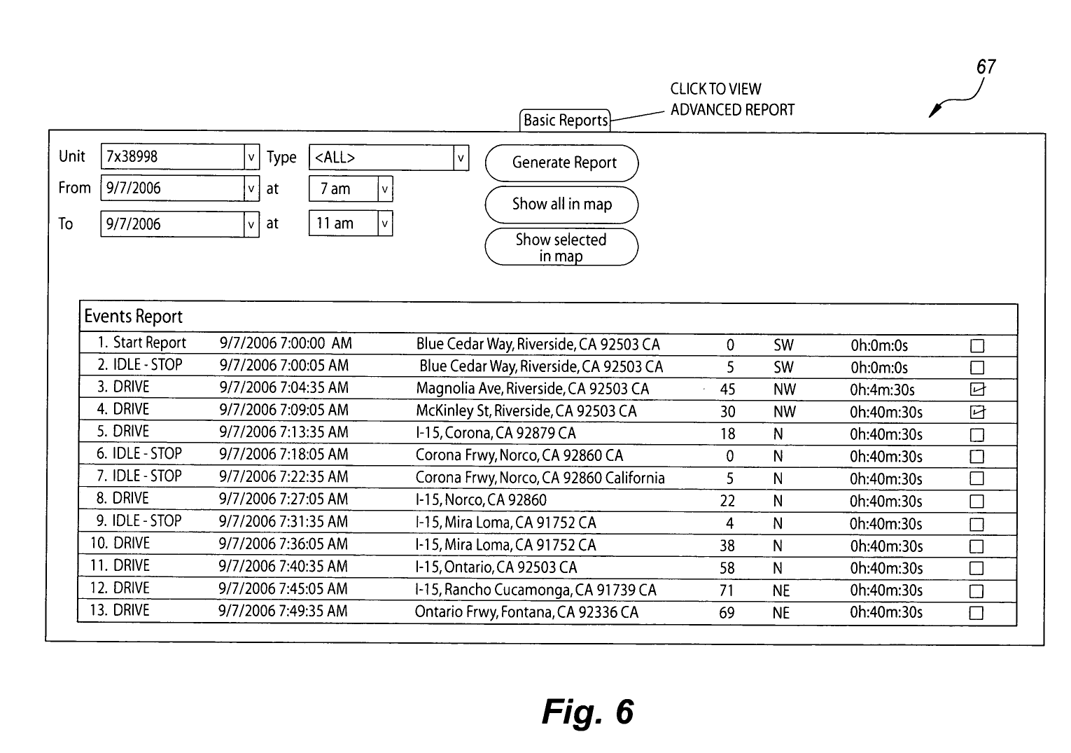

FIG. 6 illustrates a more detailed display of report information 67, containing second-by-second or minute-by-minute data of the driver's location, speed and direction. The user may further, by clicking on the boxes to the right, display maps associated with each data entry.

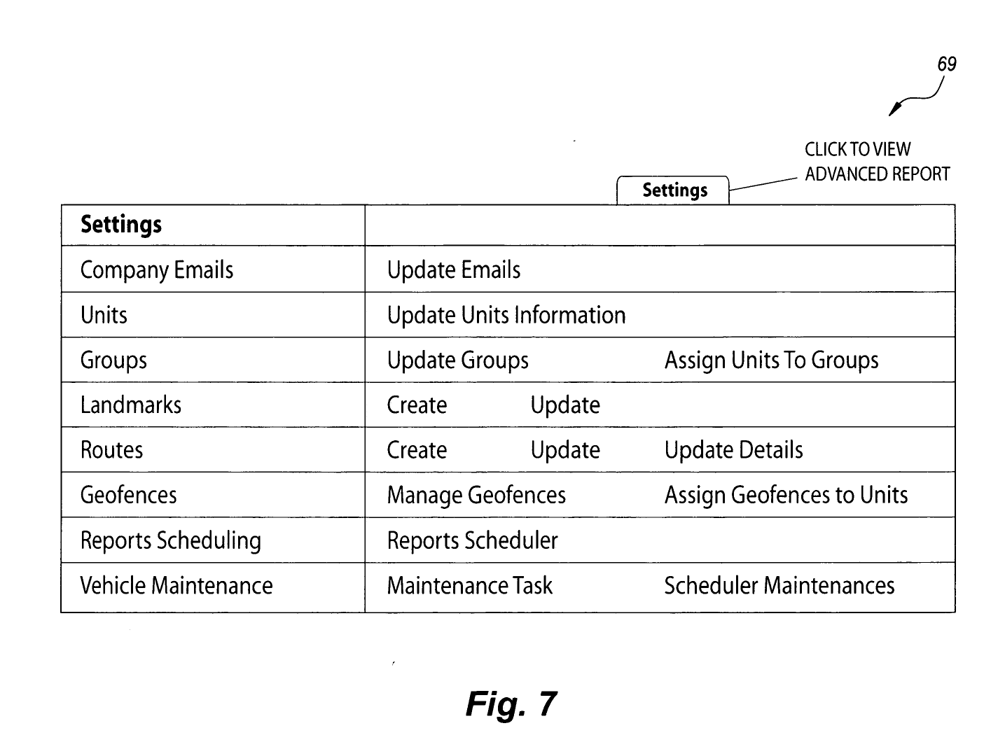

FIG. 7 illustrates a “settings” menu 69, allowing the user to change and store basic settings and configurations for e-mail programs, select destinations and locations of interest, define boundaries and virtual fences, schedule the initiation of reports, and perform and schedule vehicle maintenance tasks. The user may further define particular units of interest, or groups of units.

It is to be understood that the present invention is not limited to the embodiments described above, but encompasses any and all embodiments within the scope of the following claims.

We claim:

1. A method of using a vehicular communication and information system, comprising the steps of:
providing a computer system within a vehicle;
providing a global positioning system receiver in communication with said computer system;
determining a geographic position of the vehicle;
transmitting the geographic position of the vehicle to a remote base station; and,
recording positional and motion data associated with the vehicle at the base station.

2. The method of using a vehicular communication and information system as recited in claim 1, further comprising the step of producing a tracking report associated with the vehicle from the recorded positional and motion data.

3. The method of using a vehicular communication and information system as recited in claim 2, wherein said step of recording positional and motion data includes recording the current time and date.

4. The method of using a vehicular communication and information system as recited in claim 3, wherein said step of recording positional and motion data includes recording the speed of the vehicle.

5. The method of using a vehicular communication and information system as recited in claim 4, wherein said step of recording positional and motion data includes recording the direction of motion of the vehicle.

6. The method of using a vehicular communication and information system as recited in claim 5, wherein said step of recording positional and motion data includes recording the time duration of vehicle stops.

7. The method of using a vehicular communication and information system as recited in claim 2, further comprising the step of selectively displaying the recorded positional and motion data at the base station.

8. The method of using a vehicular communication and information system as recited in claim 7, further comprising the step of selectively displaying the recorded positional and motion data to a user in the vehicle.

9. The method of using a vehicular communication and information system as recited in claim 8, further comprising the step of generating a visual geographic map which includes the present location of the vehicle.

10. The method of using a vehicular communication and information system as recited in claim 9, further comprising the step of displaying the vehicle's intended route on said visual geographic map.

11. The method of using a vehicular communication and information system as recited in claim 10, further comprising the step of displaying the vehicle's traveled route on said visual geographic map.

12. The method of using a vehicular communication and information system as recited in claim 11, further comprising the steps of defining geographic locations of interest and selectively displaying the locations of the geographic locations of interest on the visual geographic map.

13. The method of using a vehicular communication and information system as recited in claim 12, further comprising the step of defining a geographic boundary in which the vehicle is intended to travel.

14. The method of using a vehicular communication and information system as recited in claim 13, further comprising the steps of displaying the location of the geographic boundary to the user in the vehicle and at the base station.

15. The method of using a vehicular communication and information system as recited in claim 14, further comprising the step of generating an alert signal to the user in the vehicle if the vehicle travels beyond the defined geographic boundary.

16. The method of using a vehicular communication and information system as recited in claim 15, further comprising the step of generating an alert signal at the base station if the vehicle travels beyond the defined geographic boundary.

17. The method of using a vehicular communication and information system as recited in claim 2, further comprising the step of selectively transmitting control signals from the base station to the vehicle.

18. The method of using a vehicular communication and information system as recited in claim 17, further comprising the step of selectively generating maintenance information pertaining to the vehicle.

19. The method of using a vehicular communication and information system as recited in claim 2, further comprising the step of transmitting voice signals between the vehicle and the base station.

20. The method of using a vehicular communication and information system as recited in claim 2, further comprising the step of transmitting data signals between the vehicle and the base station.

21. The method of using a vehicular communication and information system as recited in claim 2, further comprising the step of locating at least one vehicle equipped with said vehicular communication and information system within a defined geographic boundary.

22. A vehicular communication and information system, comprising:
a computer system adapted for mounting within a vehicle, said computer system being adapted for communication with a factory installed maintenance computer associated with the vehicle;
a global positioning system receiver in communication with said computer system;
a display in communication with said computer system for displaying the vehicle's position to the user;
a wireless transmitter in communication with said computer system, said wireless transmitter being adapted for selective data transmission with a base station;
a first storage means for recording positional and motion data associated with the vehicle, said first storage means being located within the vehicle; and,
a second storage means for recording positional and motion data associated with the vehicle, said second storage means being located within the base station.

23. The vehicular communication and information system as recited in claim 22, further comprising first and second alarms for generating alarm signals when the vehicle moves beyond a user-defined geographic boundary, said first alarm being located within the vehicle, said second alarm being located within the base station.

24. The vehicular communication and information system as recited in claim 22, further comprising a printer in communication with said computer system.

25. The vehicular communication and information system as recited in claim 22, further comprising a wireless interface device, whereby a passenger in the vehicle may actuate the computer system via the wireless interface device.
